(19) United States
(12) Patent Application Publication
(10) Pub. No.: US 2026/0146493 A1
(43) Pub. Date: May 28, 2026

(54) ANTI-CRACK ASSEMBLY FOR CORNER WALL OF DOOR AND WINDOW

(71) Applicants: CHIH-CHENG LIN, TAINAN CITY (TW); CHUAN-HSUAN LIN, TAINAN CITY (TW)

(72) Inventors: CHIH-CHENG LIN, TAINAN CITY (TW); CHUAN-HSUAN LIN, TAINAN CITY (TW)

(21) Appl. No.: 18/959,869

(22) Filed: Nov. 26, 2024

(51) Int. Cl. E06B 5/10

(52) U.S. Cl. CPC E06B 5/10

(57) ABSTRACT

An anti-crack assembly for corner walls of doors and windows is provided. A plurality of anti-crack components is spaced apart from one another and connected by fixing rods inserted through the anti-crack components. At least one side of a notch of the anti-crack component is connected with a resistance piece having a shape matched with the notch. Thus bond area and connection stability of the corner walls of the door and window frames are increased by the resistance piece. Anti-crack strength on the frontmost end of the corner walls is further improved. Moreover, stress generated is stopped by the resistance piece so that transmission direction of the stress is changed and resistance to the external force is generated. The external force acted on the stress end is reduced and dispersed. Therefore, resistance to the stress and anti-crack performance of the frontmost end of the corner wall are improved.

### FIELD OF THE INVENTION

The present invention relates to an anti-crack assembly used as a building component, especially to an anti-crack assembly for corner walls of doors and windows.

### DESCRIPTION OF RELATED ART

Generally, walls of buildings are installed with windows. When the building has thermal expansion or vibration due to earthquake, cracks occur around corners of window frames in the wall. Rain water can infiltrate the building through the cracks. In order to improve anti-crack strength of the wall structure around the corners of the window or door frames and protect the wall structure around the corners from cracks or micro-cracks due to earthquake or other external forces, inventors of the present invention have invented and developed products related to anti-crack assembly for corner walls of doors and windows in sequence as those revealed in Taiwanese Pat. Pub. No. I650468 “AN ANTI-CRACKING COMPONENT OF STRUCTURAL WALL FOR WINDOW CORNER”, Taiwanese Pat. Pub. No. M582057 “Fixing structure for anti-cracking component of window angle wall surface”, Taiwanese Pat. Pub. No. I695106 “ANTI-CRACKING COMPONENT STRUCTURE FOR DOOR AND WINDOW CORNER WALLS”, Taiwanese Pat. Pub. No. M594053 “Door and window corner wall crack-resisting component structure”, Taiwanese Pat. Pub. No. M592012 “Door and window corner wall surface anti-cracking component structure” in sequence.

After installation of the above door and window corner wall surface anti-cracking components, openings reserved for the door or the window are formed in the wall structure. After door and window frames being mounted into the openings, a gap generated is filled with cement mortar to form a seam. When earthquake stress is transmitted to the seam, the seam and its surface paint layer are easy to have micro-cracks. Thus the inventors of the present invention have developed “Door and window corner wall crack-resisting component structure” revealed in Taiwanese Pat. Pub. No. I708882. As shown in FIG. 7, a crack-resisting assembly m for door and window corner walls mainly includes a plurality of crack-resisting components m1 spaced apart and inserted by fixing rods m2 for connection with one another. Two reinforcement pieces m31 of a reinforcement unit m3 are connected with two ends of the fixing rods m2 and a vibration absorption member m32 is arranged between the two reinforcement pieces m31. Each of the two reinforcement pieces m31 is provided with a seam reinforcement part m33. When the crack-resisting assembly m for door and window corner walls is in use, the seam reinforcement parts m33 are connected with the seams at respective corners of the door frame and the window frame. Thus crack-resisting strength of the wall structure and the seams at the corners of the door and the window frames is increased by the arrangement of the seam reinforcement parts m33 of the reinforcement unit m3. Therefore, the seam at the corners of the door and the window frames and its paint layer are protected from having micro-cracks during the earthquake.

According to the above development history, the inventors of the present invention are dedicated to improving the related products continuously in order to make the products easier to use and more practical. Although the crack-resisting strength of the wall structure and the seams at the corners of the door and the window frames are increased by the arrangement of the reinforcement unit m3 in the Taiwanese Pat. Pub. No. I708882 “Door and window corner wall crack-resisting component structure”, the design still has certain shortcoming. The reinforcement unit m3 is mainly composed of the two reinforcement pieces m31 and the one vibration absorption member m32. While being assembled with the crack-resisting components m1, the vibration absorption member m32 needs to be fixed on notches of the plurality of the crack-resisting components m1 by spot welding. Two ends of the plurality of fixing rods m2 of the crack-resisting components m1 are inserted through and fixed on the two reinforcement pieces m31 correspondingly. Thereby not only manufacturing cost of the crack-resisting assembly m is high, assembly and use of the crack-resisting assembly m are also inconvenient. Thus there is room for improvement and there is a need to provide a novel crack-resisting assembly for door and window corner walls.

### SUMMARY OF THE INVENTION

Therefore, it is a primary object of the present invention to provide an anti-crack assembly for corner walls of doors and windows which not only features on simple structure, low production cost, and convenient installation, but also protects wall structure at corners of door and window frames from micro-cracks.

In order to achieve the above object, an anti-crack assembly for corner walls of doors and windows according to the present invention includes a plurality of anti-crack components spaced apart from one another and connected by fixing rods inserted through. At least one side of a notch of the anti-crack component is connected with a resistance piece having a shape matched with a shape of the notch. Thus bond area and connection stability of wall structure at corners of door and window frames are increased by the resistance piece. And anti-crack strength on the frontmost end of the wall structure at corners of the door and the window frames, where the forces are applied, is further improved. Moreover, stress generated due to earthquake is stopped by the resistance piece while being transmitted to the resistance piece so that transmission direction of the stress is changed and resistance to the external force is generated. Thus action of the external force on the stress end is reduced and dispersed. Thereby resistance to the stress and anti-crack performance of the force-applied frontmost end of the wall structure at corners of the door and the window frames are improved. A surface layer of the force-applied frontmost end of the wall structure is protected from cracks or micro-cracks when an earthquake is coming or other factors such as forces are applied.

### BRIEF DESCRIPTION OF THE DRAWINGS

FIG. 1 is a perspective view of an embodiment according to the present invention;

FIG. 2 is a front view of an anti-crack component according to the present invention;

FIG. 3 is a perspective view of an embodiment according to the present invention;

FIG. 4 is a schematic drawing showing an embodiment installed on a door frame and a window frame while in use according to the present invention;

FIG. 5 is a perspective view showing an embodiment mounted with reinforcing bars in use according to the present invention;

FIG. 6 is a top view showing an embodiment mounted with reinforcing bars in use according to the present invention;

FIG. 7 is a perspective view of an anti-crack assembly for corner walls of doors and windows available now.

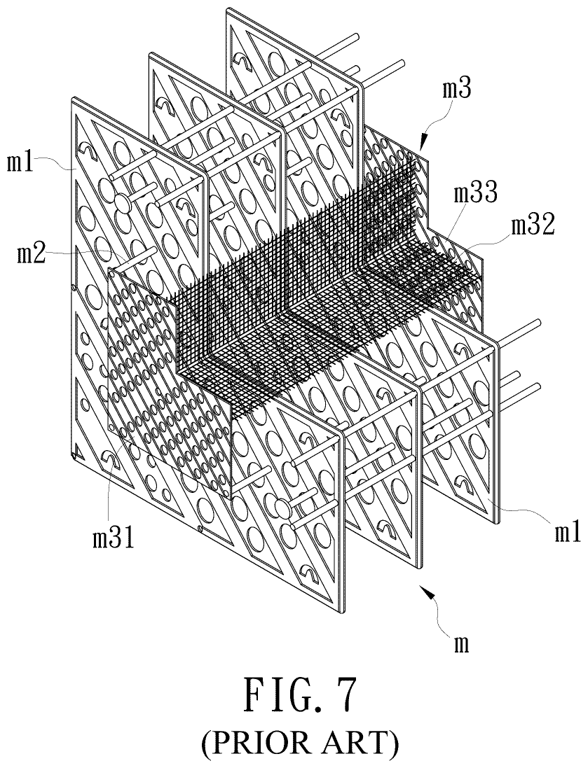

### DETAILED DESCRIPTION OF THE PREFERRED EMBODIMENT

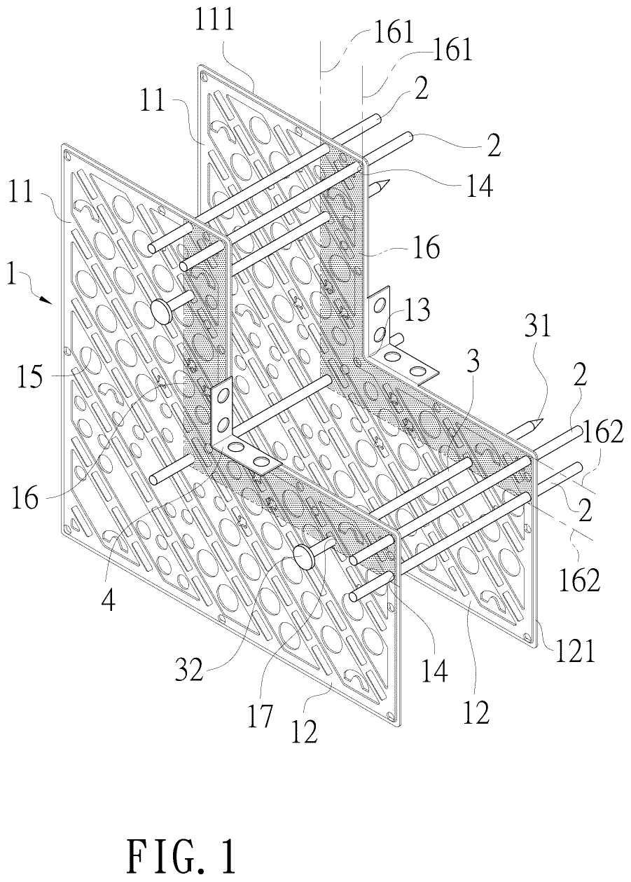

Refer to FIG. 1, an anti-crack assembly for corner walls of doors and windows according to the present invention is provided. The anti-crack assembly for corner walls of doors and windows includes a plurality of anti-crack components 1 corresponding to and spaced apart from one another, a plurality of fixing rods 2, at least one positioning rod 3, and at least one resistance piece 4.

The anti-crack component 1 arranged horizontally consists of a first piece portion 11 arranged vertically and a second piece portion 12 disposed horizontally. The first piece portion 11 and the second piece portion 12 are integrally connected to form one part in a L-shape. One side of the first piece portion 11 and one side of the second piece portion 12 are combined to form a L-shaped notch 13. Two adjacent fixing holes 14 are disposed close to the notch 13 along both an end edge 111 of the first piece portion 11 in a lengthwise direction and an end edge 121 of the second piece portion 12 in a lengthwise direction. The anti-crack component 1 is further provided with a plurality of penetrating holes 15.

Two of the fixing rods 2 are inserted through and fixed in both the two fixing holes 14 of the first piece portion 11 and the two fixing holes 14 of the second piece portion 12 of the respective anti-crack components 1 correspondingly. The first piece portion 11 is provided with two imaginary vertical lines 161 which are defined as imaginary lines vertically passed through the two of the fixing rods 2. The second piece portion 12 is provided with two imaginary horizontal lines 162 which are defined as imaginary lines horizontally passed through the another two of the fixing rods 2. An operation area 16 is formed and defined by the two imaginary vertical lines 161, the two imaginary horizontal lines 162, the end edge 111 of the first piece portion 11, and the end edge 121 of the second piece portion 12. At least one positioning hole 17 is arranged at the operation area 16.

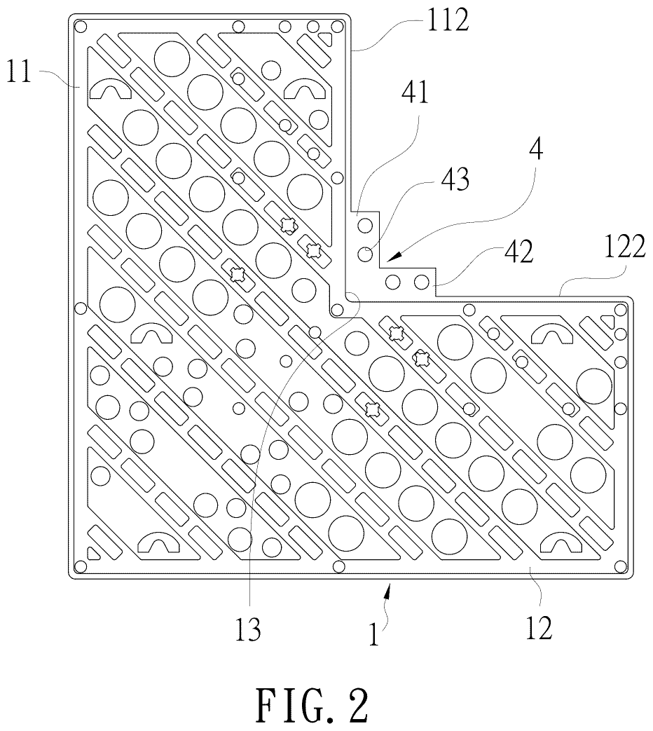

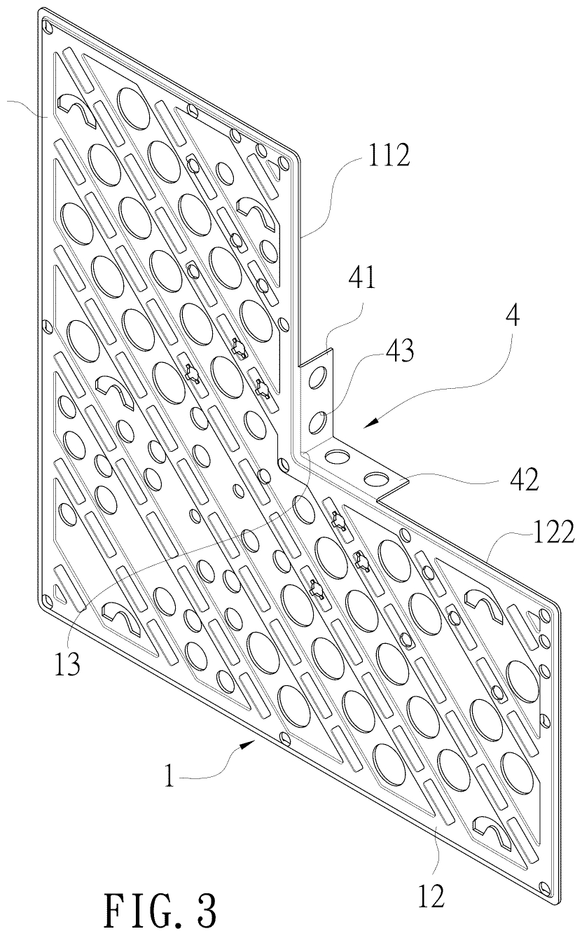

The positioning rod 3 is inserted through the positioning holes 17 of the respective anti-crack components 1 correspondingly. In this embodiment, the positioning rod 3 is an iron nail provided with a sharp end 31 and a stopping end 32 located at two opposite ends of the positioning rod 3 correspondingly. A rod surface of the positioning rod 3 is abutting against a hole wall of the positioning hole 17. Also refer to FIG. 2, the anti-crack assembly according to the present invention features on that: one side of the first piece portion 11 and one side of the second piece portion 12 which are combined to form the L-shaped notch 13 are respectively defined as a first side 112 and a second side 122. The resistance piece 4 is located at the notch 13 of the anti-crack component 1 and provided with a first sheet 41 arranged vertically and a second sheet 42 disposed horizontally. The first sheet 41 and the second sheet 42 are connected and integrated into one part. One side of the first sheet 41 of the resistance piece 4 is connected and integrated with the adjacent first side 112 of the first piece portion 11 of the anti-crack component 1 while one side of the second sheet 42 of the resistance piece 4 is connected and integrated with the adjacent second side 122 of the second piece portion 12 of the anti-crack component 1. The resistance piece 4 is provided with a plurality of through holes 43. Refer to FIG. 3, the resistance piece 4 is able to be bent toward a front side or a back side of the notch 13 of the anti-crack component 1 according to users'needs while in use. Thus a L-shaped resistance piece 4 having a shape matched with a shape of the L-shaped notch 13 is formed.

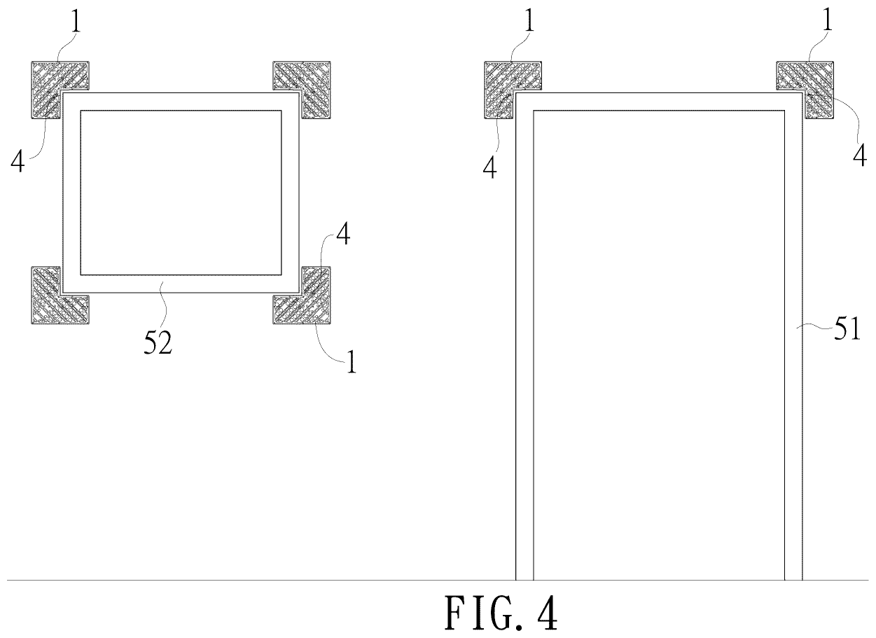

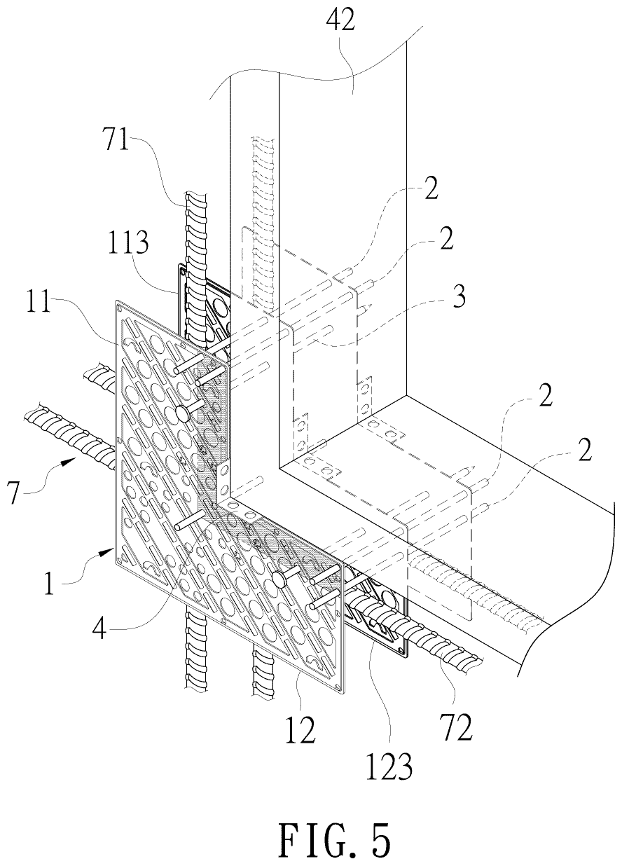

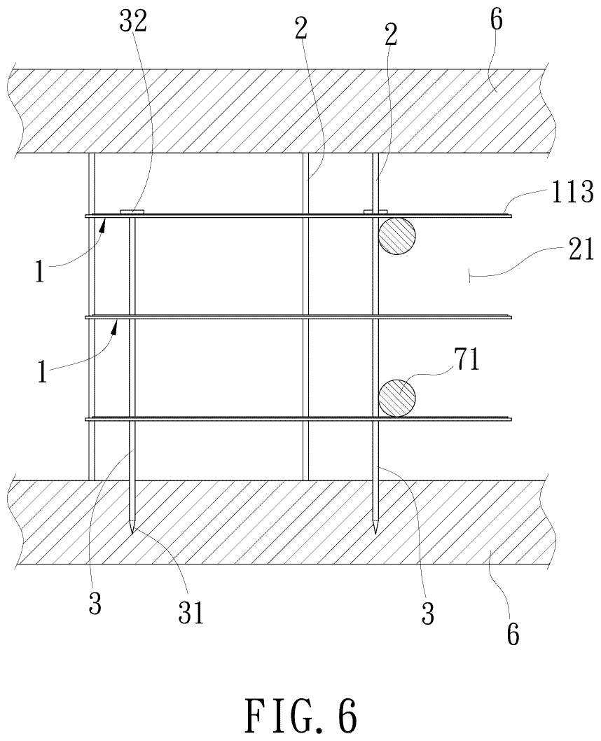

While in use, the resistance piece 4 arranged at the notch 13 of the anti-crack component 1 is bent toward the front side or the back side of the notch 13 of the anti-crack component 1 first. As shown in FIG. 4, then the present assembly is mounted to each corner of a door frame 51 or a window frame 52. The corner of the door frame 51 or the window frame 52 is abutting against both the notch 13 of the anti-crack component 1 and the resistance piece 4. Refer to FIG. 5 and FIG. 6, one end of the fixing rod 2 is abutting against a template 6 and the sharp end 31 of the positioning rod 3 is inserted and stopped in the template 6. Then the stopping end 32 of the positioning rod 3 is driven by striking tools in construction personnel's hands so that the sharp end 31 of the positioning rod 3 is driven and fixed in the template 6. After a plurality of the present assemblies being driven into the template 6 and fixed at the corners of the door and the window frames 51, 52, a plurality of reinforcing bars 7 is arranged vertically and horizontally along a periphery of the door and the window frames 51, 52. While being applied, vertical steel rebars 71 and horizontal steel rebars 72 are respectively mounted in a reinforcing bar mounting area 21 through an outer side 113 of the first piece portion 11 and an outer side 123 of the second piece portion 12. The reinforcing bar mounting area 21 is formed among the outer side 113 of the first piece portion 11, the fixing rod 2 adjacent to the outer side 113, the outer side 123 of the second piece portion 12, and the fixing rod 2 adjacent to the outer side 123. The vertical steel rebars 71 and the horizontal steel rebars 72 are respectively leaning against the fixing rod 2 adjacent to the outer side 113 of the first piece portion 11 and the fixing rod 2 adjacent to the outer side 123 of the second piece portion 12. Thereby convenience in arrangement of the reinforcing bars 7 is improved and an intersection between the vertical steel rebars 71 and the horizontal steel rebars 72 is tied and fixed by iron wires.

Next ready-mix concrete is filled into a space formed among the templates 6. At the moment, liquid concrete flows smoothly among the anti-crack components 1 and the resistance pieces 4 through the plurality of the penetrating holes 15 on the anti-crack components 1 and the through holes 43 on the resistance pieces 4 so that the respective anti-crack components 1 and the resistance pieces 4 are covered with the concrete. After solidification of the concrete into the wall structure, the present assembly are enclosed in the wall structure. The resistance piece 4 located at one side of the notch 13 of the anti-crack component 1 further increases bond area and connection stability between the present assembly and the wall structure so that anti-crack strength on the frontmost end of the wall structure at corners of the door and the window frames 51, 52, where the forces are applied, is further enhanced. When the reinforced concrete (RC) walls are driven by external forces, such as shaking caused by earthquake and thermal expansion, stress is created at corners of the door and the window frames 51, 52. When the stress is transmitted to the notch 13 of the anti-crack component 1, it's stopped by the L-shaped resistance piece 4 at the notch 13 so that transmission direction of the stress is changed and resistance to the external force is generated. Thus action of the external force on a site the stress occurs is reduced and dispersed. Therefore, resistance to the stress and anti-crack performance of the force-applied frontmost end of the wall structure at corners of the door and the window frames 51, 52 are improved. A surface layer of the force-applied frontmost end of the wall structure at corners of the door and the window frames 51, 52 is protected from cracks or micro-cracks when the forces are applied due to earthquake or other factors.

It is worth mentioning that the resistance piece 4 and the anti-crack component 1 are formed integrally. While being installed for use, the resistance piece 4 is bent to the front side or the back side of the anti-crack component 1. Owing to the integrated design of the resistance piece 4 and the anti-crack component 1, not only manufacturing cost of the present assembly is significantly reduced, installation and use of the present assembly are also more convenient. While not in use, the resistance piece 4 is integrally connected to the notch 13 of the anti-crack component 1 to form a flat plate together with the anti-crack component 1. Thereby the resistance piece 4 will not occupy space in front of or behind the notch 13 of the anti-crack component 1. This helps saving cost for storage and transportation.

The above embodiments or figures are not intended to limit implementations of the present invention. Besides the L shape, the notch 13 of the anti-crack component 1 and the resistance piece 4 can be curved or in other shapes. The resistance piece 4 which is integrally connected to the notch 13 of the anti-crack component 1 is bent to the front side or the back side of the notch 13 of the anti-crack component 1 during installation or in use. Or the resistance piece 4 is connected to the front side or the back side of the notch 13 of the anti-crack component 1 by spot welding in advance. In other embodiment, two L-shaped resistance pieces 4 are provided and connected to the front side and the back side of the notch 13 of the anti-crack component 1 correspondingly by spot welding. Therefore, at least one of the front side and the back side of the notch 13 of the anti-crack component 1 is connected with the resistance piece 4 having a shape matched with the shape of the notch 13 of the anti-crack component 1.

In summary, the present assembly has the following advantages.

1. A resistance piece is connected to at least one side of the notch of the anti-crack component. Thus bond area and connection stability of the force-applied frontmost end of the wall structure at corners of the door and the window frames is increased and anti-crack strength on the force-applied frontmost end of the wall structure at corners of the door and the window frames is further enhanced.

2. A L-shaped resistance piece is connected to at least one side of the notch of the anti-crack component. When the stress generated due to earthquake is transmitted to the L-shaped resistance piece, it's stopped by the L-shaped resistance piece so that transmission direction of the stress is changed and resistance to the external force is generated. Thus the external force acted on the stress is reduced and dispersed. Therefore, resistance to the stress and anti-crack performance of the force-applied frontmost end of the wall structure at corners of the door and the window frames are improved. A surface layer of the force-applied frontmost end of the wall structure at corners of the door and the window frames is protected from cracks or micro-cracks.

3. The improvement of the present assembly is in that a resistance piece is connected to at least one side of the notch of the anti-crack component. By the design of such simple structure, not only the resistance to the stress and anti-crack performance of the force-applied frontmost end of the wall structure at corners of the door and the window frames are improved, manufacturing cost of the present assembly is also significantly saved and installation and uses of the present assembly are more convenient.

4. The improvement of the present assembly is in that a resistance piece is integrally formed on the notch of the anti-crack component to form a flat plate together with the anti-crack component. Thereby the resistance piece will not occupy space in front of or behind the notch of the anti-crack component. This helps saving cost for storage and transportation.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An anti-crack assembly for corner walls of doors and windows comprising:
a plurality of anti-crack components corresponding to and spaced apart from one another; each of the anti-crack components having a first piece portion arranged vertically and a second piece portion disposed horizontally; the first piece portion and the second piece portion integrally connected to form one part; one side of the first piece portion and one side of the second piece portion combined to form a notch; two adjacent fixing holes disposed close to the notch along both an end edge of the first piece portion and an end edge of the second piece portion;
a plurality of fixing rods each of which being inserted through and fixed in both each of the two fixing holes of the first piece portion and each of the two fixing holes of the second piece portion of the respective anti-crack components correspondingly; the first piece portion provided with two imaginary vertical lines which are defined as imaginary lines vertically passed through two of the fixing rods; the second piece portion provided with two imaginary horizontal lines which are defined as imaginary lines horizontally passed through two of the fixing rods; an operation area defined by the two imaginary vertical lines, the two imaginary horizontal lines, the end edge of the first piece portion, and the end edge of the second piece portion; at least one positioning hole arranged at the operation area;
at least one positioning rod inserted through the positioning holes of the respective anti-crack components correspondingly and fixed on a template; the anti-crack assembly is characterized in that:
a resistance piece having a shape matched with a shape of the notch is connected to at least one side of the notch of the anti-crack component.

2. The anti-crack assembly as claimed in claim 1, wherein the resistance piece is provided with a plurality of through holes.

3. The anti-crack assembly as claimed in claim 1, wherein the notch of the anti-crack component is in a L shape and the resistance piece is in a L shape matched with the L shape of the notch of the anti-crack component.

4. The anti-crack assembly as claimed in claim 1, wherein the anti-crack component is provided with a plurality of penetrating holes.

5. The anti-crack assembly as claimed in claim 1, the one side of the first piece portion and the one side of the second piece portion combined to form the notch are respectively defined as a first side and a second side; the resistance piece is located at the notch of the anti-crack component and provided with a first sheet arranged vertically and a second sheet disposed horizontally which are connected and integrated into one part; one side of the first sheet of the resistance piece is connected and integrated with the adjacent first side of the first piece portion of the anti-crack component while one side of the second sheet of the resistance piece is connected and integrated with the adjacent second side of the second piece portion of the anti-crack component; the resistance piece is able to be bent toward one side of the notch of the anti-crack component and having a shape matched with a shape of the notch of the anti-crack component.

6. The anti-crack assembly as claimed in claim 5, wherein the resistance piece is provided with a plurality of through holes.

7. The anti-crack assembly as claimed in claim 5, wherein the notch of the anti-crack component is in a L shape and the resistance piece is in a L shape matched with the L shape of the notch of the anti-crack component.

8. The anti-crack assembly as claimed in claim 5, wherein the anti-crack component is provided with a plurality of penetrating holes.
